(19) United States
(12) Patent Application Publication
(10) Pub. No.: US 2016/0375566 A1
(43) Pub. Date: Dec. 29, 2016

(54) TIGHTENING TOOL FOR COAXIAL CONNECTORS

(71) Applicant: CommScope Technologies LLC, Hickory, NC (US)

(72) Inventors: Aviral Joshi, Chicago, IL (US); Michael R. Schaefer, Tinley Park, IL (US); Frank A. Harwath, Naperville, IL (US); David B. Brown, New Lenox, IL (US)

(21) Appl. No.: 15/152,447

(22) Filed: May 11, 2016

Related U.S. Application Data
(60) Provisional application No. 62/185,138, filed on Jun. 26, 2015.

(51) Int. Cl. B25B 23/142; H01R 13/623; H01R 24/38; B25B 23/14; B25B 13/06

(52) U.S. Cl. CPC B25B 23/1427; B25B 23/141; B25B 13/06; H01R 24/38; H01R 13/623

(57) ABSTRACT

A tool for tightening a coupling nut includes: a hollow shaft having a length, an outer diameter, and a thickness, the hollow shaft including a longitudinal gap extending between a first end and a second end of the shaft, the shaft being formed of a resilient material; and a plurality of faces located on an inner diameter of the shaft adjacent one of the ends, the faces arranged to receive a coupling nut. The dimensions and material are selected so that, when the faces of the tool engage a coupling nut and a torque is applied to the shaft below a preselected level, the faces maintain engagement with the coupling nut, thereby rotating the coupling nut, but when a torque exceeding the preselected level is applied to the shaft, the shaft deflects sufficiently that the faces slip relative to the coupling nut, thereby preventing rotation of the coupling nut.

### RELATED APPLICATION

The present application claims priority from and the benefit of U.S. Provisional Patent Application No. 62/185,138, filed Jun. 26, 2016, the disclosure of which is hereby incorporated herein in its entirety.

### FIELD OF THE INVENTION

The present invention relates generally to tools, and more particularly to tools for tightening coaxial connectors.

### BACKGROUND

A ganged set of mated coaxial connectors, designated broadly at 100, is shown in FIG. 1A. Each of coaxial connectors 102 includes a coupling nut 104 that is employed to secure the connector 102 to a mating coaxial connector 106 that is part of a ganged connector interface (i.e, the coaxial connectors 106 are mounted as a group in a common mounting platform, such as a panel for a remote radio head or the like). Each of the connectors 102 is attached to a cable 108. As can be seen in FIG. 1A, there is relatively little space between connectors for a conventional tool to tighten the coupling nuts 104. Often, a gap no more than about ¾ inch to 1 inch is present between adjacent connectors 106. As such, it may be desirable to provide a tool that can be employed to tighten the coaxial connectors 102 onto the connectors 106 simply and easily.

### SUMMARY

As a first aspect, embodiments of the invention are directed to a tool for tightening a coupling nut. The tool comprises: a hollow shaft having a length, an outer diameter, and a thickness, the hollow shaft including a longitudinal gap extending between a first end and a second end of the shaft, the shaft being formed of a resilient material; and a plurality of faces located on an inner diameter of the shaft adjacent one of the ends, the faces arranged to receive a coupling nut. The outer diameter, the thickness, the gap and the resilient material are selected so that, when the faces of the tool engage a coupling nut and a torque is applied to the shaft below a preselected level, the faces maintain engagement with the coupling nut, thereby rotating the coupling nut, but when a torque exceeding the preselected level is applied to the shaft, the shaft deflects sufficiently that the faces slip relative to the coupling nut, thereby preventing rotation of the coupling nut.

As a second aspect, embodiments of the invention are directed to a method of tightening a coupling nut, comprising the steps of: (a) providing a tightening tool comprising: a hollow shaft having a length, an outer diameter, and a thickness, the hollow shaft including a longitudinal gap extending between a first end and a second end of the shaft, the shaft being formed of a resilient material; and a plurality of faces located on an inner diameter of the shaft adjacent one of the ends, the faces arranged to receive a coupling nut; (b) inserting a cable terminated with a first connector into the shaft through the gap; (c) mating the first connector with a second connector, wherein one of the first and second connectors includes a coupling nut; (d) engaging the coupling nut with the faces of the tool; and (e) applying a torque to the shaft to rotate the tool relative to the nut, wherein when the torque applied to the shaft is below a preselected level, the faces maintain engagement with the coupling nut, thereby rotating the coupling nut, but when the torque exceeds the preselected level is applied to the shaft, the shaft deflects sufficiently that the faces slip relative to the coupling nut, thereby preventing rotation of the coupling nut.

As a third aspect, embodiments of the invention are directed to a method of tightening a coupling nut, comprising the steps of: (a) providing a tightening tool comprising: a hollow shaft having a length, an outer diameter, and a thickness, the hollow shaft including a longitudinal gap extending between a first end and a second end of the shaft, the shaft being formed of a resilient material; and a plurality of faces located on an inner diameter of the shaft adjacent one of the ends, the faces arranged to receive a coupling nut; (b) inserting a cable terminated with a first connector into the shaft through the gap; (c) mating the first connector with a second connector that is one of a plurality of second connectors arranged as a ganged set of connectors mounted on a common substrate, wherein one of the first and second connectors includes a coupling nut; (d) engaging the coupling nut with the faces of the tool; and (e) applying a torque to the shaft to rotate the tool relative to the nut, wherein when the torque applied to the shaft is below a preselected level, the faces maintain engagement with the coupling nut, thereby rotating the coupling nut, but when the torque exceeds the preselected level is applied to the shaft, the shaft deflects sufficiently that the faces slip relative to the coupling nut, thereby preventing rotation of the coupling nut.

### BRIEF DESCRIPTION OF THE FIGURES

FIG. 1A is a perspective view of a series of ganged coaxial connectors.

FIG. 1B is a perspective view of the series of ganged coaxial connectors of FIG. 1 to be secured with a tool according to embodiments of the invention.

FIG. 2 is a perspective view of a tightening tool to be used on the connectors of FIG. 1.

FIG. 3 is a top view of the tightening tool of FIG. 2.

FIG. 4 is a bottom view of the tightening tool of FIG. 2.

FIG. 5 is a left side view of the tightening tool of FIG. 2.

FIG. 6 is a right side view of the tightening tool of FIG. 2.

FIG. 7 is a front view of the tightening tool of FIG. 2.

FIG. 8 is a rear view of the tightening tool of FIG. 2.

### DETAILED DESCRIPTION

The present invention will be described more particularly hereinafter with reference to the accompanying drawings. The invention is not intended to be limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated liked items. Where used, the terms “attached”, “connected”, “interconnected”, “contacting”, “coupled”, “mounted” and the like can mean either direct or indirect attachment or contact between elements, unless stated otherwise.

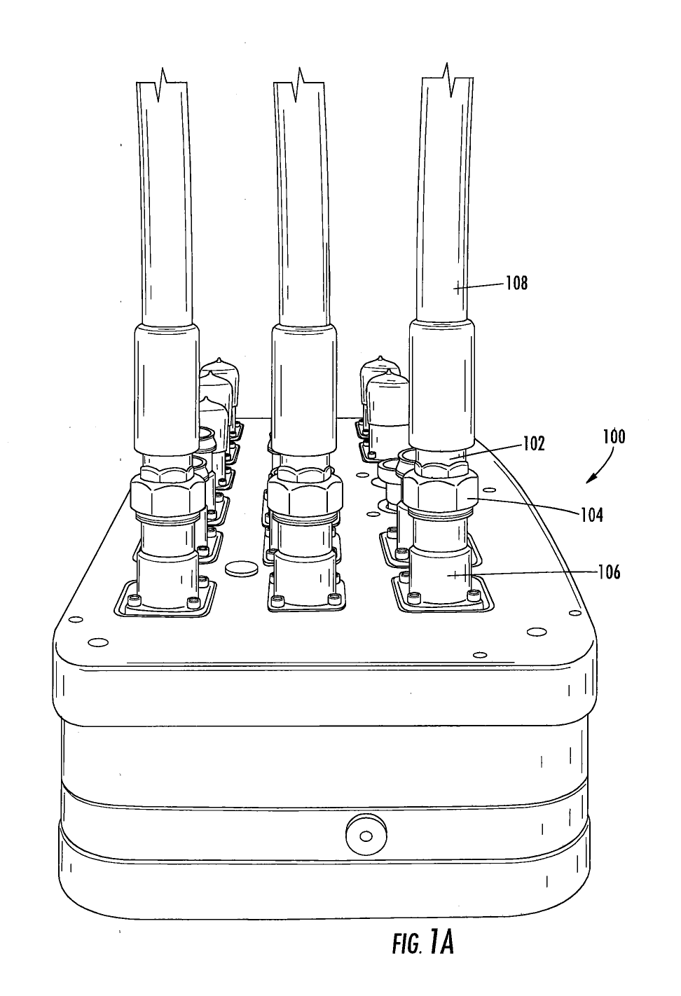

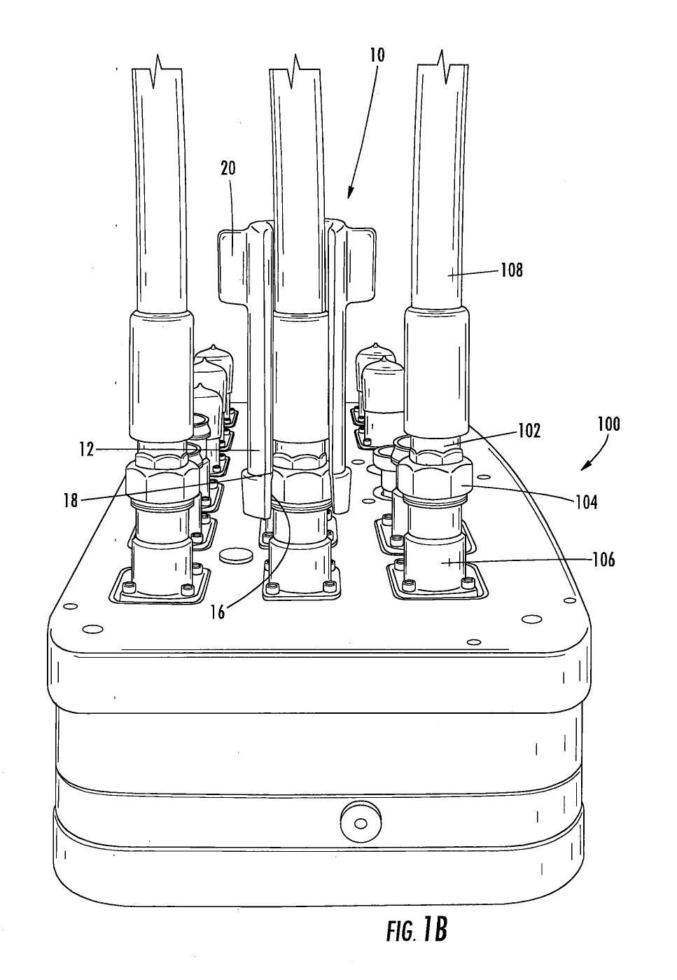

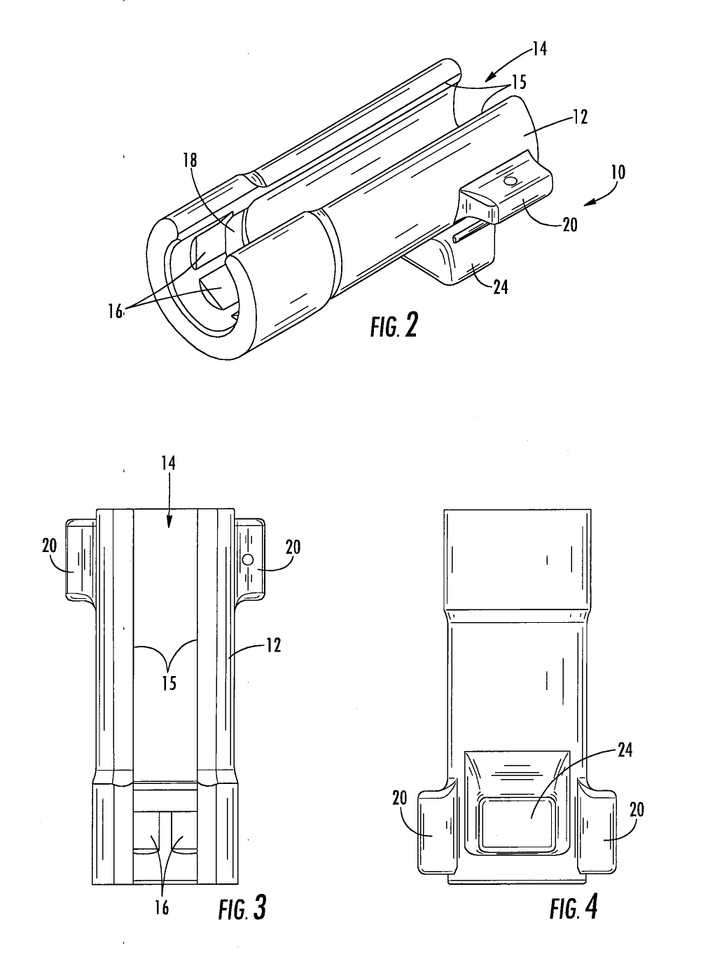

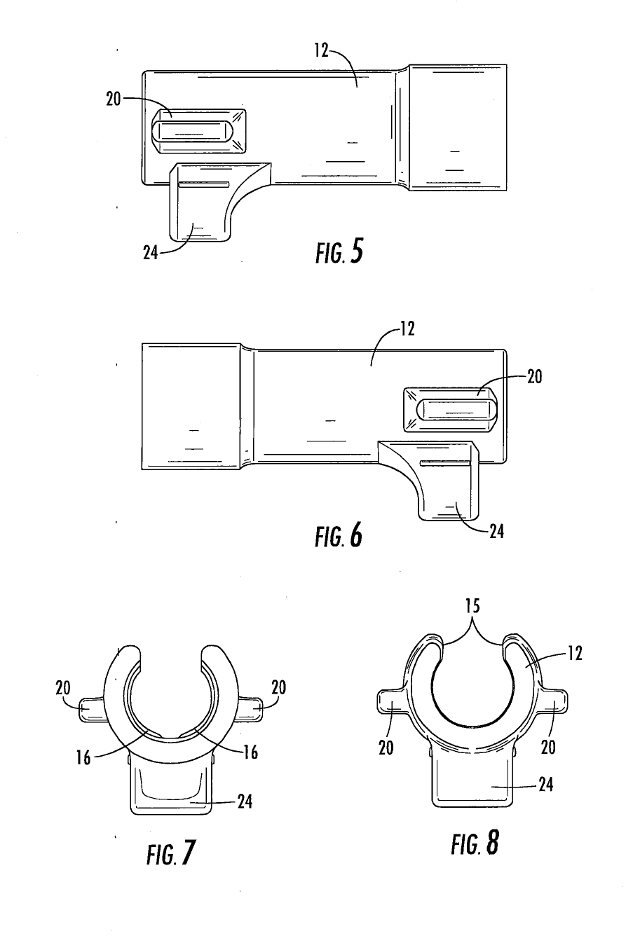

Referring now to the figures, as can be seen in FIG. 1A and as discussed above, there is relatively little space between connectors for a tool to tighten the coupling nuts of ganged coaxial connectors: Such a tightening operation may be accomplished with the assistance of the tightening tool illustrated in FIGS. 1B-8 and designated broadly at 10. The tool 10 includes a generally hollow cylindrical shaft 12 with a longitudinal slot 14 that extends the full length of the shaft 12 and is defined by edges 15. At one end, the inner diameter of the shaft 12 has flat faces 16 that define a portion of a hexagonal wrench (more specifically, in the illustrated embodiment, four of the six faces of a typical hex wrench are present, although this number may vary). A shoulder 18 resides adjacent the hex faces 16.

In some embodiments, the shaft 12 is between about 3.8 and 3.9 inches in length, between about 1.4 and 1.6 inches in outer diameter, and between about 0.2 and 0.4 inches in thickness (as used herein, thickness is intended to measure the difference in the inner and outer diameters of the shaft 12). The gap 14 may be between about 0.63 and 0.65 inches in width.

At the opposite end of the shaft 12, two wings 20 extend radially outwardly from diametrically opposite sides of the outer surface of the shaft 12. Also, a projection 24 extends radially outwardly from the outer surface of the shaft 12 opposite the slot 14. The projection 24 is sized to receive a conventional torque wrench. As an example, the projection may have a width of about 0.866 inch and a thickness of about 0.629 inch, which can enable it to receive a standard 22 mm torque wrench.

The tool 10 may be formed of any suitable material, but the material should be chosen so that its stiffness, in combination with the dimensions of the shaft 12 and/or other portions of the tool 10, can deflect under a preselected torque magnitude. Exemplary materials include polymeric materials such as nylon 6,6 and polypropylene (either of which may be reinforced with fillers), metallic materials such as aluminum, and the like. In some embodiments, the tool is formed by injection molding.

In operation, the tool 10 can be inserted onto a cable by slipping the cable through the gap 14, with the end having the faces 16 directed toward a connector 102 at the end of the cable 108. Because the thickness of the tool 10 is relatively small, the shaft 12 is able to fit between adjacent ganged connectors 102. Once the connector 102 is mated with a mating connector 108, the tool 10 can slide along the cable 108 until the hex faces 16 engage the hex surfaces of the coupling nut 104 and the shoulder 18 abuts the coupling nut 104 (see FIG. 1). The tool 10 is then rotated to twist the coupling nut 104 onto threads of the mating connector 106. The tool 10 can be rotated by hand (for example, by grasping the wings 20) or via a conventional wrench (for example, by engaging the projection 24 with the wrench).

Notably, and as discussed above, the dimensions and material of the tool 10 are selected so that, as the torque applied to the tool reaches a predetermined amount, the shaft 12 deflects sufficiently that the faces 16 “slip” from the coupling nut. This occurs as the excessive torque causes the edges 15 that line the gap 14 of the shaft to separate slightly, thereby deflecting the hex faces 16 to a slightly larger arc and preventing the faces 16 from remaining in sufficient contact with the coupling nut 104 to turn it. Thus, the tool 10 can act as a torque-limiting wrench to prevent the coupling nut from being over-torqued.

As an example, in one embodiment the preselected torque magnitude is between about 4 and 6 ft-lb. This torque magnitude can be achieved with a tool formed of nylon 6,6 (30 percent glass loaded), wherein the shaft 12 has an outer diameter of 1.5 inches and a thickness of 0.354 inches, with a gap 14 of 0.640 inches in width. Those of skill in this art will appreciate that other preselected torque levels may be achieved by varying the material and/or the dimensions of the tool.

It should also be noted that, although coaxial connectors shown herein have a configuration that meets the requirements of the 4.3/10 interface proposed in IEC61169-54, the tool 10 may be used to secure other coaxial connectors.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

That which is claimed is:

1. A tool for tightening a coupling nut, comprising:
a hollow shaft having a length, an outer diameter, and a thickness, the hollow shaft including a longitudinal gap extending between a first end and a second end of the shaft, the shaft being formed of a resilient material;
a plurality of faces located on an inner diameter of the shaft adjacent one of the ends, the faces arranged to receive a coupling nut;
wherein the outer diameter, the thickness, the gap and the resilient material are selected so that, when the faces of the tool engage a coupling nut and a torque is applied to the shaft below a preselected level, the faces maintain engagement with the coupling nut, thereby rotating the coupling nut, but when a torque exceeding the preselected level is applied to the shaft, the shaft deflects sufficiently that the faces slip relative to the coupling nut, thereby preventing rotation of the coupling nut.

2. The tool defined in claim 1, wherein the resilient material is selected from the group consisting of: nylon 6,6 and polypropylene.

3. The tool defined in claim 1, further comprising wings extending radially outwardly from the shaft.

4. The tool defined in claim 1, further comprising a projection extending radially outwardly from the shaft configured to receive a torque wrench.

5. The tool defined in claim 1, wherein the plurality of faces is four faces.

6. The tool defined in claim 1, wherein the thickness of the shaft is between about 0.2 and 0.4 inch, and the outer diameter of the shaft is between about 1.4 and 1.6 inches.

7. The tool defined in claim 1, wherein the preselected torque level is between about 4 and 6 ft-lbs.

8. A method of tightening a coupling nut, comprising the steps of:
(a) providing a tightening tool comprising:
a hollow shaft having a length, an outer diameter, and a thickness, the hollow shaft including a longitudinal gap extending between a first end and a second end of the shaft, the shaft being formed of a resilient material;
a plurality of faces located on an inner diameter of the shaft adjacent one of the ends, the faces arranged to receive a coupling nut;
(b) inserting a cable terminated with a first connector into the shaft through the gap;
(c) mating the first connector with a second connector, wherein one of the first and second connectors includes a coupling nut;
(d) engaging the coupling nut with the faces of the tool; and
(e) applying a torque to the shaft to rotate the tool relative to the nut, wherein when the torque applied to the shaft is below a preselected level, the faces maintain engagement with the coupling nut, thereby rotating the coupling nut, but when the torque exceeds the preselected level is applied to the shaft, the shaft deflects sufficiently that the faces slip relative to the coupling nut, thereby preventing rotation of the coupling nut.

9. The method defined in claim 8, wherein the resilient material is selected from the group consisting of: nylon 6,6 and polypropylene.

10. The method defined in claim 8, wherein the tool further comprises wings extending radially outwardly from the shaft, and wherein step (e) comprises grasping the wings to rotate the shaft.

11. The method defined in claim 8, further comprising a projection extending radially outwardly from the shaft, and wherein step (e) comprising grasping the projection with a torque wrench to rotate the shaft.

12. The method defined in claim 8, wherein the plurality of faces is four faces.

13. The method defined in claim 8, wherein the thickness of the shaft is between about 0.2 and 0.4 inch, and the outer diameter of the shaft is between about 1.4 and 1.6 inches.

14. The method defined in claim 8, wherein the preselected torque level is between about 4 and 6 ft-lbs.

15. A method of tightening a coupling nut, comprising the steps of:
(a) providing a tightening tool comprising:
a hollow shaft having a length, an outer diameter, and a thickness, the hollow shaft including a longitudinal gap extending between a first end and a second end of the shaft, the shaft being formed of a resilient material;
a plurality of faces located on an inner diameter of the shaft adjacent one of the ends, the faces arranged to receive a coupling nut;
(b) inserting a cable terminated with a first connector into the shaft through the gap;
(c) mating the first connector with a second connector that is one of a plurality of second connectors arranged as a ganged set of connectors mounted on a common substrate, wherein one of the first and second connectors includes a coupling nut;
(d) engaging the coupling nut with the faces of the tool; and
(e) applying a torque to the shaft to rotate the tool relative to the nut, wherein when the torque applied to the shaft is below a preselected level, the faces maintain engagement with the coupling nut, thereby rotating the coupling nut, but when the torque exceeds the preselected level is applied to the shaft, the shaft deflects sufficiently that the faces slip relative to the coupling nut, thereby preventing rotation of the coupling nut.

16. The method defined in claim 15, wherein the resilient material is selected from the group consisting of: nylon 6,6 and polypropylene.

17. The method defined in claim 15, wherein the tool further comprises wings extending radially outwardly from the shaft, and wherein step (e) comprises grasping the wings to rotate the shaft.

18. The method defined in claim 15, further comprising a projection extending radially outwardly from the shaft, and wherein step (e) comprising grasping the projection with a torque wrench to rotate the shaft.
